(19) United States
(12) Patent Application Publication
(10) Pub. No.: US 2021/0373355 A1
(43) Pub. Date: Dec. 2, 2021

(54) LIGHT FIELD VOLUMETRIC DEVICE FOR DISPLAYING FLUCTUATING AND STEREOSCOPIC 3D IMAGES FLOWS AND METHOD THEREOF

(71) Applicant: 3D.I.V.E. S.R.L., VERONA (IT)

(72) Inventors: Enrico BENASSI, COSTRIGNANO DI PALAGANO (IT); Giovanni TREGNAGHI, BRESCIA (IT); Fabrizio LIBERATI, ROMA (IT); Sara MAUTINO, DRUENTO (IT); Anto ROSSETTI, FONTANAFREDDA (IT)

(21) Appl. No.: 16/759,301

(22) PCT Filed: Oct. 26, 2018
(86) PCT No.: PCT/IB2018/058365

§ 371 Date: Apr. 24, 2020

(30) Foreign Application Priority Data
Oct. 27, 2017 (IT) 102017000122280

(51) Int. Cl. G02B 30/56; G02B 17/06; G02B 30/26; H04N 13/388

(52) U.S. Cl. CPC G02B 30/56; H04N 13/388; G02B 30/26; G02B 17/0621

(57) ABSTRACT

A light field volumetric device for displaying images or flows of fluctuating and stereoscopic 3D images. The device includes emitting means and a reflection system. The reflection system has first and second concave reflecting means. The first concave reflecting means comprises an aperture. An image generated by the device is perceivable by an observer, located at a distance with respect to the second concave reflecting means, when the observer looks towards the second concave reflecting means. A calculation unit is associated with the device and is configured to calculate the distance.

### FIELD OF APPLICATION

The object of the present invention is a light field volumetric device.

In particular, the object of the invention is a light field volumetric device for displaying flows of fluctuating and stereoscopic 3D images.

A method for displaying flows of fluctuating and stereoscopic images constitutes a further object of the invention.

In other words, the object of the present invention is a device/method which enables flows of 3D images to be displayed, starting from 2D images, without requiring any display media.

### PRIOR ART

One of today's major efforts at the scientific and technological level concerns the creation of 3D displays. In the past, the absence of a sufficiently developed background made the creation of displays of this type inconceivable. Today there are several options for creating 3D displays, which, however, involve some critical points. In particular, depending on the technology used, volumetric 3D displays can present limitations affecting resolution capacity, the number of voxels, playback speed, loss of brightness and light intensity, the required use of vacuum chambers (which are costly and hazardous), the need to thermostat the system, a limited viewing angle, excessive proximity of the projected image to the device, limitations involving the display dimensions, scaling issues, possible blurring of image due to scattering phenomena, self-occlusion caused by the opacity of LED components and connection wires, and fabrication complexity. Moreover, in many cases, it has been noted that such systems may be potentially hazardous to the eyes.

As mentioned above, current developments of volumetric 3D displays on the technological and scientific front have focused on devising technologies suitable for creating a display that is physically three-dimensional.

Projection systems for projecting fluctuating images which attempt to obtain three-dimensional, stereoscopic, pseudo-holographic effects have been proposed, apparently without significant results.

These systems are difficult to model and optimize, which leads to unpredictable results. In addition, they do not make it possible to reproduce a natural stereoscopic view.

As a result, they have not proved to be sufficiently efficient, comfortable or tolerable by users to be produced on a large scale and used in daily life.

The aim of the present invention is to create a light field volumetric device (and a corresponding method) for displaying images or flows of fluctuating and stereoscopic 3D images that is capable of overcoming the problems of the prior art, that is, a device which above all actually works and is efficient.

A particular aim of the present invention is to create a device/method as stated above which is capable of converting images or a flow of images of any 2D display into a fluctuating, stereoscopic three-dimensional image that is perceivable as such by an observer without any supplementary viewing device such as eyeglasses, displays or other display media.

### SUMMARY OF THE INVENTION

In a first aspect of the invention, these and other aims are achieved by a light field volumetric device for displaying images or flows of fluctuating and stereoscopic 3D images comprising:

emitting means configured to transmit a beam of light rays in first directions representing a two-dimensional image flow;

a reflection system coupled to the emitting means, in turn comprising:
first concave reflecting means configured to receive the beam of light rays and to reflect the beam in second directions obtained as a function of the first directions and of a first conformation of the first concave reflecting means;
second concave reflecting means configured to receive the beam of light rays along the second directions and to reflect the beam in third directions obtained as a function of the second directions and of a second conformation of the second concave reflecting means;

wherein the first concave reflecting means is mounted, with respect to the second concave reflecting means, with concavities facing one another and coaxial;

wherein foci of the first concave reflecting means and of the second concave reflecting means lie on a straight line that defines the azimuth axis of the reflection system;

wherein the first concave reflecting means and the second concave reflecting means, or prolongations thereof, intersect along an intersection curve lying on a reference plane perpendicular to the azimuth axis of the reflection system;

wherein the first concave reflecting means comprises at least one aperture configured so that the beam of light rays, reflected by the second concave reflecting means, exits from the reflection system along the third directions through the at least one aperture;

wherein an image generated as a function of the beam of light rays is perceived by an observer, located at a positioning distance with respect to the second concave reflecting means, when the observer looks towards the second concave reflecting means along two visual cones having respective directrices;

wherein vertices of the two cones coincide with the observation points of the observer;

wherein the cones intersect the second concave reflecting means along respective distinct curves having respective areas;

a calculation unit associated with the device and configured to calculate the positioning distance along a reference direction defined as a function of the directrices and of the third directions;

wherein the device further comprises:

regulating means adapted to vary the reference direction for determining a superposing measurement of the areas, thus realising a visual effect of the image as a three-dimensional image, fluctuating and stereoscopic about a fluctuation point for the observer located at the calculated positioning distance

In a second aspect of the invention, these and other aims are achieved by a method of displaying images or flows of fluctuating and stereoscopic 3D images comprising the steps of:

predisposing emitting means;

predisposing a reflection system, coupled to the emitting means, comprising first concave reflecting means and second concave reflecting means;

predisposing the first concave reflecting means mounted, with respect to the second concave reflecting means, with concavities facing one another and coaxial;

predisposing foci of the first concave reflecting means and of the second concave reflecting means lying on a straight line that defines the azimuth axis of the reflection system;

intersecting the first concave reflecting means and the second concave reflecting means, or prolongations thereof, along an intersection curve lying on a reference plane perpendicular to the azimuth axis of the reflection system;

transmitting by the emitting means, a beam of light rays representing a two-dimensional image flow, in first directions;

receiving the beam of light rays by the first concave reflecting means and reflecting the beam in second directions obtained as a function of the first directions and of a first conformation of the first concave reflecting means;

receiving the beam of light rays along the second directions by second concave reflecting means and reflecting the beam in third directions obtained as a function of the second directions and of a second conformation of the second concave reflecting means;

predisposing an aperture in the first concave reflecting means, the aperture being configured so that the beam of light rays, reflected by the second concave reflecting means, exits from the reflection system along the third directions through the at least one aperture;

wherein an image generated as a function of the beam of light rays is perceived by an observer, located at a positioning distance with respect to the second concave reflecting means, when the observer looks towards the second concave reflecting means along two visual cones having respective directrices;

causing vertices of the two cones to coincide with the observation points of the observer;

intersecting the cones and the second concave reflecting means along respective distinct curves having respective areas;

calculating the positioning distance along a reference direction defined as a function of the directrices and of the third directions;

varying the reference direction for determining a superposing measurement of the areas, thus realising a visual effect of the image as a three-dimensional image, fluctuating and stereoscopic about a fluctuation point for the observer located at the calculated positioning distance.

In a third aspect of the invention, these and other aims are achieved by a television for projecting flows of fluctuating and stereoscopic 3D images comprising receiving means for receiving a digital televisual signal;

a light field volumetric device for displaying flows of fluctuating and stereoscopic 3D images, according to one of the preceding aspects, and configured to receive the digital televisual signal, and wherein

the emitting means is configured to:
receive an input signal defined as a function of the digital televisual signal;
emit a beam of light rays representing a two-dimensional image flow, the images being defined as a function of said input signal;

wherein the light field volumetric display device is configured to realise a visual effect of a three-dimensional image, fluctuating and stereoscopic about the fluctuation point for the observer located at a calculated positioning distance.

In a fourth aspect of the invention, these and other aims are achieved by a light field volumetric device for displaying images or flows of fluctuating and stereoscopic 3D images comprising:

emitting means configured to transmit a beam of light rays in first directions representing a two-dimensional image flow;

a reflection system, coupled to the emitting means, in turn comprising:
first concave reflecting means configured to receive the beam of light rays and to reflect the beam in second directions obtained as a function of the first directions and of a first conformation of the first concave reflecting means;
second concave reflecting means configured to receive the beam of light rays along the second directions and to reflect the beam in third directions obtained as a function of the second directions and of a second conformation of the second concave reflecting means;

wherein said first concave reflecting means is mounted, with respect to the second concave reflecting means, with concavities facing one another and coaxial;

wherein foci of the first concave reflecting means and of the second concave reflecting means lie on a straight line that defines the azimuth axis of the reflection system;

wherein the first concave reflecting means and the second concave reflecting means, or prolongations thereof, intersect along an intersection curve lying on a reference plane perpendicular to the azimuth axis of the reflection system;

wherein the first concave reflecting means comprises at least one aperture configured so that the beam of light rays, reflected by the second concave reflecting means, exits from the reflection system along the third directions through the at least one aperture;

wherein an image generated as a function of the beam of light rays is perceived by an observer, located at a predefined positioning distance with respect to the second concave reflecting means, when the observer looks towards the second concave reflecting means along two visual cones having respective directrices;

wherein vertices of the two cones coincide with the observation points of the observer;

wherein the cones intersect the second concave reflecting means along respective distinct curves having respective areas;

wherein the device determines a superposing measurement of the areas, thus realising a visual effect of said image as a three-dimensional image, fluctuating and stereoscopic about a fluctuation point for an observer located at a predefined positioning distance along a reference direction defined as a function of the directrices and the third directions.

In one or more of the preceding aspects, the vertices of the two cones coincide with the observation points of the observer, the observation points having a mean observation point and a predefined distance.

In one or more of the preceding aspects, the calculation unit is configured to calculate the positioning distance along the reference direction defined as a function of the point of intersection of the directrices and of the mean observation point.

In one or more of the preceding aspects, the emitting means is contained in the reflection system.

In one or more of the preceding aspects, the emitting means is offset with respect to the azimuth axis.

In one or more of the preceding aspects, the emitting means is configured to emit the beam of light rays via a first portion of emitting means arranged at a first mean distance from the reference plane.

In one or more of the preceding aspects, the emitting means further comprises a second portion of emitting means arranged at a second mean distance from the reference plane, wherein the second mean distance is smaller than the first mean distance, wherein the second portion of emitting means is black or dark.

In one or more of the preceding aspects, the conformation of the concave reflecting means comprises one or more of the following: concavity, opacity, roughness, colour, etc.

In one or more of the preceding aspects, the intersection curve comprises one from among a circumference, an arc of circumference, or another portion of flat curve.

In one or more of the preceding aspects, the first concave reflecting means is mounted superiorly with respect to the second concave reflecting means with respective concavities facing one another and coaxial.

In one or more of the preceding aspects, the reference plane separates the first concave reflecting means from the second concave reflecting means.

In one or more of the preceding aspects, the aperture is carried out at a focus of the second concave reflecting means.

In one or more of the preceding aspects, the regulating means is adapted to vary the reference direction for setting, for each said observer, a measurement of the superposing in a viewing range comprised between:

a first lower limit measurement of superposing below which the observer is prevented from having a stereoscopic view;

a second upper measurement limit above which the observer perceives the images as being substantially identical.

Preferably, the measurement of the superposing is in a first functional relation with the positioning distance.

Preferably, the measurement of the superposing is in a second functional relation with the predefined distance.

Preferably, the first lower limit measurement of superposing is a lower threshold value such that the first and second functional relations determine a ratio of the predefined distance to a viewing distance that is less than or equal to about 0.28.

Preferably, the second upper limit measurement of superposing is an upper threshold value such that the first and second functional relations determine a ratio of the predefined distance to a viewing distance that is greater than or equal to about 0.06;

wherein the first lower limit measurement of superposing and the second upper measurement limit define the viewing range within which the measurement can vary.

In one or more of the preceding aspects, the fluctuation point is positioned along the reference direction, wherein the fluctuation point and the mean observation point are arranged at a reciprocal viewing distance defined as a function of the fluctuation point.

Preferably, the fluctuation point is calculated at a fluctuation distance from the second reflecting means.

Preferably, the fluctuation distance is in a functional relation with the conformations and the first directions.

In one or more of the preceding aspects, a support means is provided and is adapted to support the reflection system.

In one or more of the preceding aspects, the regulating means preferably comprises electromechanical regulating means adapted to regulate the position of the reflection system on the support means.

The electromechanical regulating means preferably comprises mechanical and/or pneumatic and/or electromagnetic means or the like.

Preferably, the electromechanical means is adapted to regulate one or more of the following:

a first rotation angle of the reference plane, obtained by rotating the reference plane about a fixed rotation axis corresponding to the intersecting line between the reference plane and a first plane passing through the observation points and through the intersection point;

a second rotation angle of the reference plane, obtained by rotating the reference plane about a rotation axis corresponding to the azimuth axis;

a measurement of a first translation of the reflection system so that the reflection system translates along any one straight line belonging to the improper beam of parallel lines lying on the first plane and perpendicular to the reference direction;

a measurement of a second translation of the reflection system so that the reflection system translates along any one straight line parallel to the reference direction;

a measurement of a third translation of the reflection system so that the reflection system translates along any one straight line parallel to the azimuth axis.

In one or more of the preceding aspects, the regulating means preferably comprises a control unit configured to control the regulation of the reflection system.

Preferably, the control unit comprises:

a first direction regulation module configured to regulate the first rotation angle;

a second direction regulation module configured to regulate the second rotation angle;

a first translation regulation module configured to regulate a measurement of a first translation;

a second translation regulation module configured to regulate a measurement of a second translation;

a third translation regulation module configured to regulate a measurement of a third translation.

Preferably, the first reflecting means and the second reflecting means are identical.

Preferably, the first reflecting means and the second reflecting means comprise mirrors.

Preferably, the first reflecting means and the second reflecting means comprise paraboloids or portions thereof.

In one or more of the preceding aspects, a control apparatus is provided and it is adapted to activate, as a function of the positioning distance, one or more of the regulating means for regulating one or more of the following:
the first rotation angle;
the second rotation angle;
the measurement of the first translation;
the measurement of the second translation;
the measurement of the third translation.

Preferably, the control apparatus comprises the calculation unit configured to calculate the positioning distance along the reference direction defined as a function of the directrices and the third directions.

In one or more of the preceding aspects, the emitting means preferably lies on an emitting plane having:

a first angulation obtained by rotating the emitting plane about a straight line parallel to the reference plane, parallel to an azimuth plane and passing through the centre of gravity of the emitting means, wherein the first orientation is in a functional relation with a dihedral angle formed by the first plane and the reference plane;

wherein the azimuth plane is a plane containing the azimuth axis, perpendicular to the reference plane and parallel to the straight line conjoining the extremities of the arc of circumference or portion of flat curve obtained by intersecting the first and second reflecting means;

wherein the regulation of the first angulation minimises the angle of exit of the beam of light rays from the apertures along the third directions with respect to a straight line parallel to the azimuth axis, thus enabling projection of vertical images;

wherein the second angulation is obtained by rotating the emitting plane about a rotation axis corresponding to the straight line perpendicular to the reference plane, parallel to the azimuth axis and passing through the centre of gravity of the emitting means;

wherein the second angulation is adapted to maximise the angle of vision of the observer.

Preferably, the emitting means is translatable as a function of one or more of the following:

a first translation value of the emitting means along a first straight line contained in the reference plane P, perpendicular to the azimuth plane and passing through the azimuth axis;

a second translation value of the emitting means along a second straight line parallel to the azimuth axis;

a third translation value of the emitting means along a third straight line contained in the reference plane P and parallel to the azimuth plane;

wherein the first translation value, the second translation value and the third translation value define a trio of translation values for the emitting means.

Preferably, in one or more of the preceding aspects, the emitting means is translatable between:

a first limit value in the trio of values when:
the beam of light rays along the second directions d2i away from the first concave reflecting means intersects the second concave reflecting means inside at least one of the areas;
the emitting means does not intersect at least one of the cones;

a second limit value in the trio of values when:
the beam of light rays along the third directions d3i away from said second concave reflecting means intersects the area inside the border defined by the aperture;
the emitting means does not intersect at least one of the cones;

wherein the limit values define a range;

wherein the trio of values takes on values within the range.

In one or more of the preceding aspects, translation means for translating the emitting means is provided and adapted to translate the latter in one or more of the directions of the first, second and third straight lines.

The translation means preferably comprises motors, particularly stepper motors. Preferably, one or more of the preceding aspects is implemented by means of a computer.

In a fifth aspect, the invention comprises a computer program, which is configured to carry out the steps of one or more of the preceding aspects, when running.

The invention achieves a plurality of technical effects:

1. The device makes it possible to obtain fluctuating images, distant from the source, in the absence of mechanical media (such as screens, semi-transparent mirrors, cascades of droplets of water, fumes, aerosols, etc.), unlike that which occurs in currently devised three-dimensional image reconstruction devices.

2. The device makes it possible to obtain fluctuating images at a much greater distance compared to that obtained by the devices of the prior art. This effect is obtained by translating the emitter with respect to the azimuth axis.

3. By means of the device, it is possible to create fluctuating images (or sequences of fluctuating images) that do not appear to be confined in boxes (of various shapes), holes or other forms of mechanical confinement.

4. Through the regulation systems (as described herein below), the device makes it possible to regulate the position of the image, enlarge or scale down the initial image (or the sequence of images), be it projected, reconstructed or displayed on the display. Regulation systems are not present in previous cases described in the literature.

5. The device makes it possible to achieve the projection of images (or sequences of images) perceived as fluctuating and suspended in air, not requiring that the image displayed on the display be realized by means of a number of cameras located at different angles.

6. Through suitable dimensioning of the system and regulation, the device offers the possibility of realizing semi-transparent images or sequences of semi-transparent images in a simple manner, starting from a two-dimensional image or sequence of two-dimensional images.

7. The modelling of the device, which has been devised and created taking into account the natural stereoscopic vision of humans and their field of view, together with the regulation components, makes it possible to widen the observation window around a given direction of sight, maintaining a view that is comfortable and not harmful for the user.

8. By means of the optical systems inserted in the device, it is possible to reproduce images that are distant from the device, generated at different points and reproduced at different points without the need for waveguides or light pipes.

9. The 3D fluctuating image recreated maintains its optical characteristics even if a solid object passes along it (for example, the image can be “touched” without altering it)

The technical effects/advantages cited and other technical effects/advantages of the invention will emerge in further detail from the description provided herein below of an example embodiment and they are provided by way of approximate and non-limiting example with reference to the attached drawings.

### BRIEF DESCRIPTION OF THE DRAWINGS

FIG. 1 is a first schematic view of a first embodiment of the device of the invention.

FIG. 2 is a second schematic view of the first embodiment of the device of the invention.

FIG. 3 is a third schematic view of the first embodiment of the device of the invention.

FIGS. 3A and 3B are detailed schematic views of parts appearing in FIG. 3.

FIG. 4 is a first schematic view of a second embodiment of the device of the invention.

FIG. 4B is a particular simplified conformation of FIG. 4 used to describe a mathematical simulation of the invention.

FIG. 4C is a geometric representation showing the effect of the mathematical simulation of the present invention.

FIG. 5 is a second schematic view of the second embodiment of the device of the invention.

FIG. 6 is a schematic view of geometric references among the components of the device of the invention, particularly in relation to the emitting means.

FIG. 7 is a schematic view of geometric references among the components of the device of the invention, particularly in relation to the regulating means.

### DETAILED DESCRIPTION

The device of the invention comprises a light field volumetric device for displaying 3D images or sequences of 3D images.

It can find application, for example but not exclusively, as a television, monitor, display or another apparatus suitable for displaying graphics. Thanks to the disclosed device, it is possible to create a stereoscopic image, having depth and being suspended, particularly at a considerable distance from the device, without necessarily using anaglyph techniques, polarized light, alternating fields, lenticular screens, chromatic shifting, or holographic components.

The effect can be obtained by means of a purely optical system or in combination with suitable software processing, starting solely from an image or from a video sequence (in two dimensions) generated by a display or by another reproduction means.

By means of the invention, the starting image or video sequence can be perceived by the observer as fluctuating and having three-dimensional depth. The final effect is such as to appear as a hologram or film sequence of suspended holograms in three dimensions.

The device makes it possible to recreate stereoscopic images having the same characteristics of natural stereopsis in humans. This enables greater realism and tolerability and correct perception of an object's three-dimensionality.

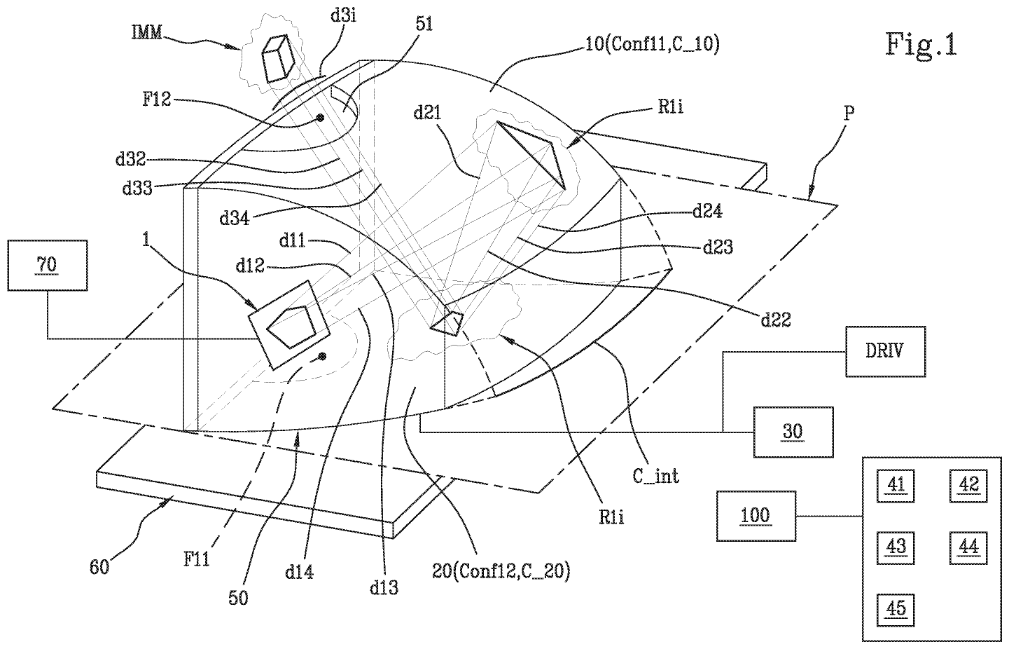

Referring generally to FIG. 1, a light field volumetric device, according to the invention, for displaying images or flows of fluctuating and stereoscopic 3D images is shown.

The English-language term light field volumetric device is currently adopted internationally.

The device of the invention comprises emitting means 1.

The emitting means preferably comprises at least one from among a monitor, a display or the like.

The device of the invention further comprises a reflection system 50, 150 coupled to the emitting means 1.

In preferred embodiments of the invention, the emitting means 1 is contained in the reflection system 50,150.

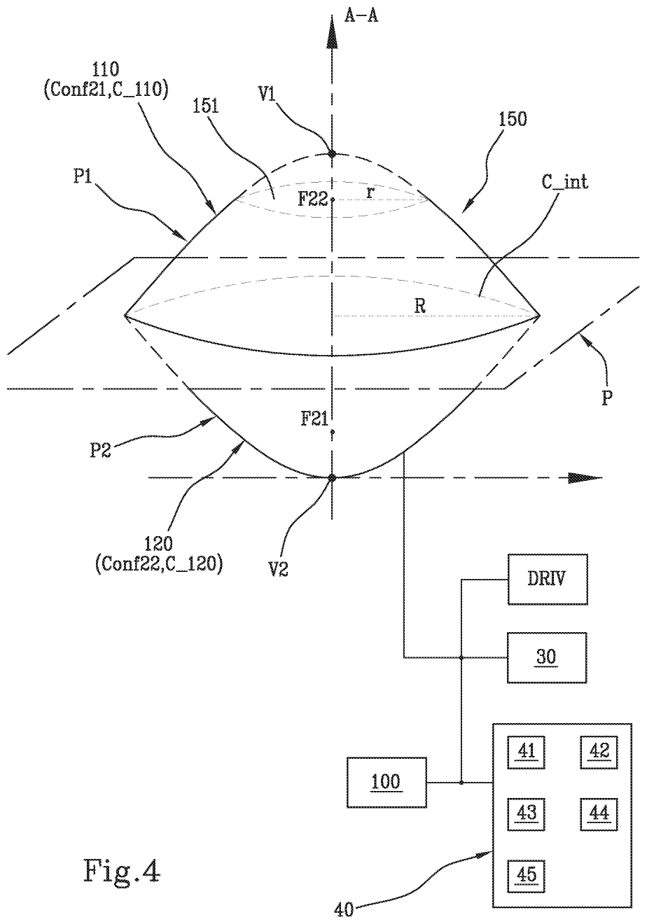

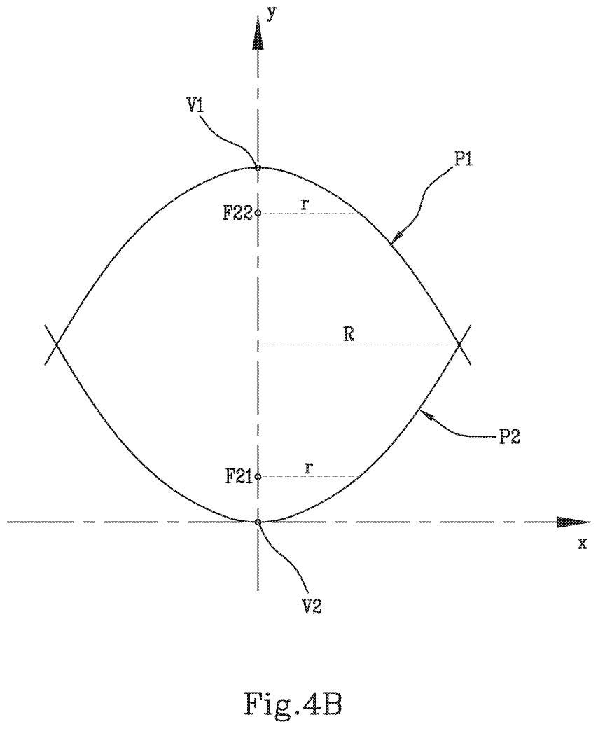

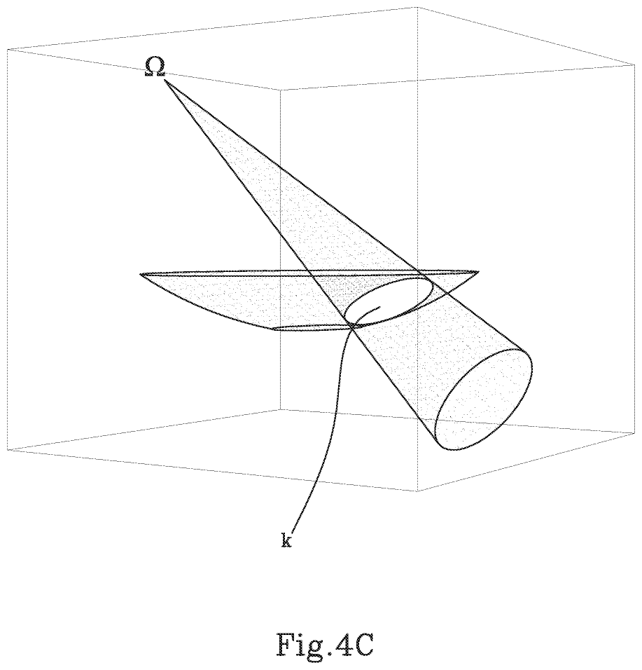

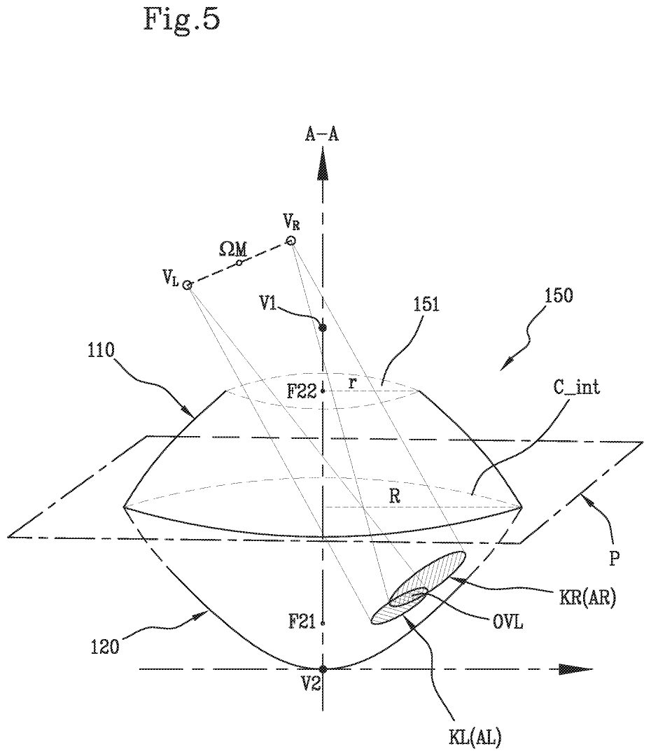

In particular, a first and a second embodiment of the invention are shown in FIGS. 1 to 3 and in FIGS. 4 and 5, respectively, and in which the emitting means 1 are contained in the first reflection system 50 and in the second reflection system 150, respectively.

According to the invention, the emitting means 1 is offset with respect to the azimuth axis A-A of the reflection system 50, 150, as shall be described in further detail herein below.

The emitting means 1 is configured to transmit a beam of light rays R1i in first directions d1i.

In particular and referring specifically to FIG. 1, the first directions d1i comprise respective directions d11, d12, d13, d14 of light rays comprised in the beam.

According to the invention, the beam of light rays R1i represents a two-dimensional image flow.

The reflection system 50, 150 according to the invention comprises:

first concave reflecting means 10, 110 configured to receive the beam of light rays R1i and to reflect the beam in second directions d2i obtained as a function of the first directions d1i and of a first conformation Conf11, Conf21 of the first concave reflecting means 10, 110.

In particular, the conformation Conf11, Conf21 of the first concave reflecting means 10,110 comprises one or more of the following: concavity, opacity, roughness, colour, etc.

In one preferred embodiment of the invention, the conformation Conf11, Conf21 coincides with a concavity C_10, C_110 of the concave reflecting means 10.

The reflection system further comprises:

second concave reflecting means 20,120 configured to receive the beam of light rays R1i along the second directions d2i and to reflect the beam in third directions d3i obtained as a function of the second directions d2i and of a second conformation Conf12, Conf22 of the second concave reflecting means 20,120.

It is understood that the beam is reflected in the third directions d3i moving away from the second reflecting means 20, 120.

In other words, the third directions d3i define the direction of the beam through which the image represented by the beam is projected, which, after subsequent transformations, will determine a three-dimensional image IMM.

Therefore, the resulting technical effect is the projection of a three-dimensional image.

In particular, the conformation Conf12, Conf22 of the second concave reflecting means 20,120 comprises one or more of the following: concavity, opacity, roughness, colour, etc.

In one preferred embodiment of the invention, the conformation Conf12, Conf22 coincides with a concavity C_20, C_120 of the second concave reflecting means 20,120.

According to the invention, the first concave reflecting means 10,110 is mounted, with respect to the second concave reflecting means 20,120, with concavities C_10, C_110; C_20, C_120 facing one another and coaxial.

In particular, the first concave reflecting means 10,110 is mounted superiorly, with respect to the second concave reflecting means 20,120, with the respective concavities C_10, C_110; C_20, C_120 facing one another and coaxial.

Preferably, the first reflecting means 10,110 and the second reflecting means 20,120 are identical.

Preferably, the first reflecting means 10,110 and the second reflecting means 20,120 comprise mirrors.

Preferably, the mirrors can be Fresnel mirrors or other types of mirrors suitable for containing the dimensions of the system 50,150.

Preferably, the mirrors can be adaptive mirrors or generally variable focal length mirrors.

Preferably, the first reflecting means 10,110 and the second reflecting means 20,120 comprise paraboloids or portions thereof.

Preferably, depending on the inclination of the emitting means 1, the first reflections can occur on the second concave reflecting means 20, 120 or on the first concave reflecting means 10, 110.

In the preferred embodiments of the invention, the case in which the first reflections occur on the first concave reflecting means 10, 110 is considered.

In the first embodiment of the invention, particularly as shown in FIG. 1, the foci F11, F12 of the first concave reflecting means 10 and of the second concave reflecting means 20, respectively, lie on a straight line that defines the azimuth axis A-A of the first reflection system 50.

Referring particularly to FIG. 1, according to the invention the prolongations of the first concave reflecting means 10 and of the second concave reflecting means 20 intersect along an intersection curve C_int lying on a reference plane P perpendicular to the azimuth axis A-A of the reflection system 50.

In the second embodiment of the invention, as shown in FIGS. 4 and 5, second foci F21, F22 of the first concave reflecting means 110 and of the second concave reflecting means 120, respectively, lie on a straight line that defines the azimuth axis A-A of the second reflection system 150.

In this embodiment, the first concave reflecting means 110 and the second concave reflecting means 120 intersect along the intersection curve C_int lying on the reference plane P perpendicular to the azimuth axis A-A of the second reflection system 150.

In particular, for both embodiments, the reference plane P separates the first concave reflecting means 10,110 from the second concave reflecting means 20,120.

In the first embodiment of the invention, the intersection curve C_int comprises an arc of circumference.

In the second embodiment of the invention, the intersection curve C_int comprises a circumference.

In alternative embodiments, the intersection curve C_int comprises a generic portion of flat curve.

Advantageously, according to the invention, the first concave reflecting means 10,110 comprises at least one aperture 51, 151.

In particular, in the first embodiment of the invention, the first concave reflecting means 10 comprises at least one aperture 51.

The aperture 51 is carried out at the focus F12 of the second concave reflecting means 20.

In particular, in the second embodiment of the invention, the first concave reflecting means 110 comprises at least one aperture 151.

The aperture 151 is carried out at the focus F22 of the second concave reflecting means 120.

According to the invention, the aperture 51, 151 is configured so that the beam of light rays R1i, reflected by the second concave reflecting means 20,120, exits from the reflection system 50,150 along the third directions d3i through the at least one aperture 51, 151.

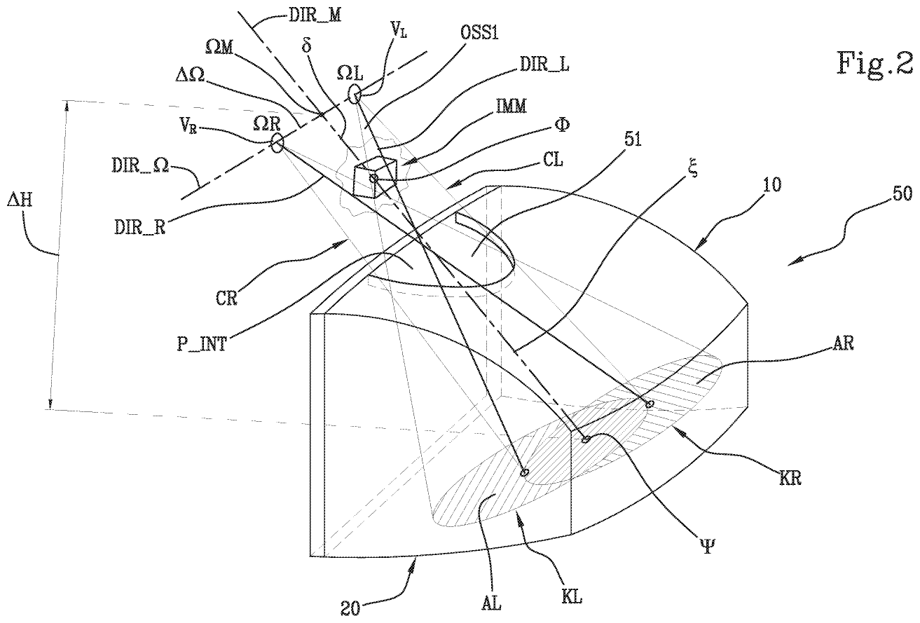

An observer who is observing the device of the invention at a positioning distance Δh (shown for example in FIG. 2), with respect to the second concave reflecting means 20,120, perceives the three-dimensional image IMM as an image that is three-dimensional and fluctuating.

As mentioned previously, according to the invention, the emitting means 1 is offset with respect to the azimuth axis A-A of the reflection system 50,150.

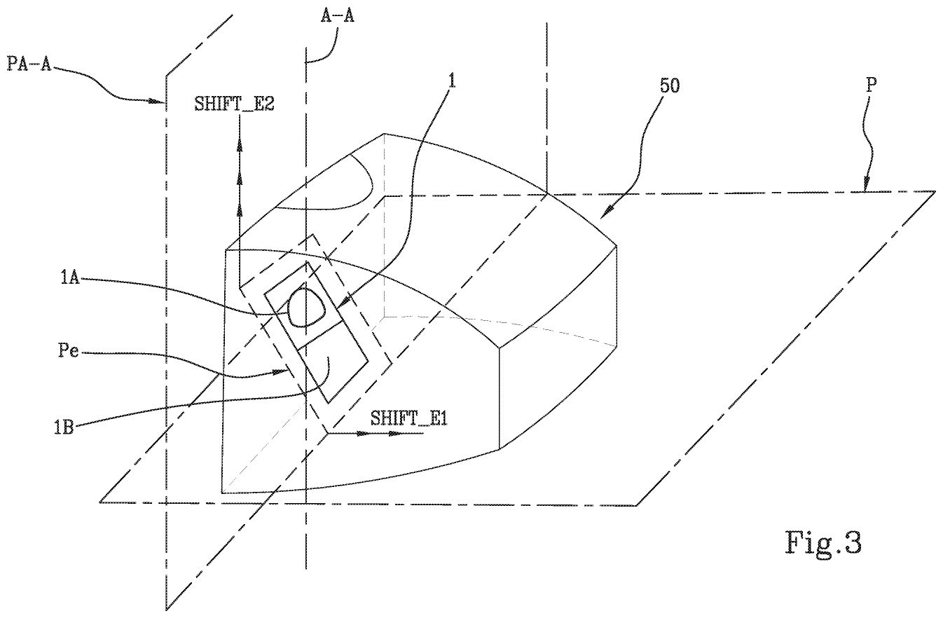

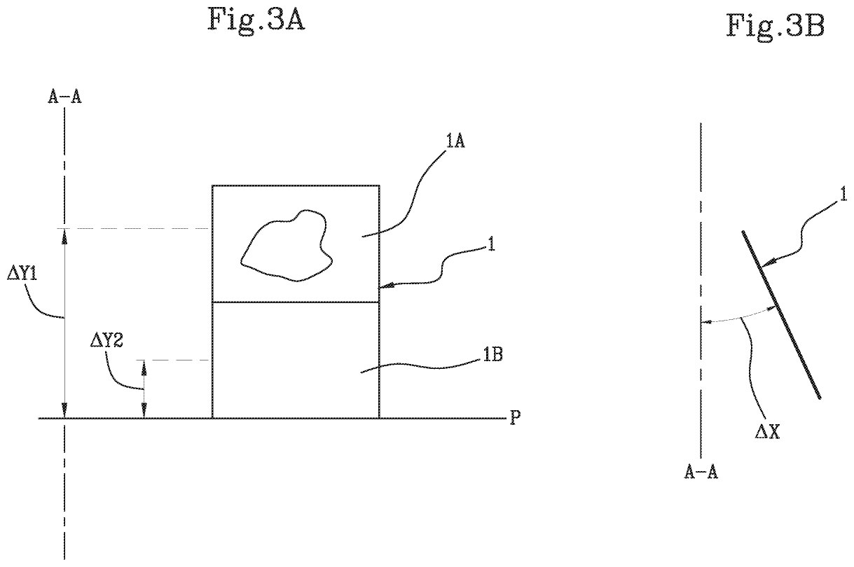

In other words, the azimuth axis A-A of the reflection system 50, 150 does not pass through the emitting means 1, and the emitting means 1 is arranged at a mean working distance Δx (FIG. 3b) from the azimuth axis A-A calculated on the reference plane P, so as to enable a display of the fluctuating image IMM with an enlargement that is proportional to the mean working distance Δx.

The technical effect achieved by this positioning of the emitting means 1 is a reconstruction of the fluctuating image of considerable dimensions with respect to the image displayed on the emitting means 1.

For example, if the centre of gravity of the emitting means 1 is positioned on the azimuth axis A-A, the image will be re-proposed as 1:1 out of the reflection system 50, 150 at a height corresponding to the dimensions of the emitter.

If the centre of gravity of the emitting means 1 is shifted, preferably towards the curve C_INT at a certain distance from the azimuth axis A-A, the image of the emitting means 1 shall be enlarged, even a number of times. As a result, a detail of the image will be displayed out of the aperture at a height proportional to the enlargement of the image.

Referring to FIGS. 3 and 3A, in one embodiment the emitting means 1 is configured to emit the beam of light rays R 1 via a first portion of emitting means 1A arranged at a first mean distance Δy1 from the reference plane P, wherein the first mean distance Δy1 is calculated parallel to the azimuth axis A-A.

Referring again to FIGS. 3 and 3A, the emitting means further comprises a second portion of emitting means B arranged at a second mean distance Δy2 from the reference plane P, wherein the second mean distance Δy2 is smaller than the first mean distance (Δy1 and calculated parallel to the azimuth axis A-A.

According to the invention, the second portion of emitting means 1B is black or dark.

The technical effect achieved by the particular configuration of the described emitting means 1 is that a detail of the image (necessarily comprised in the first portion of emitting means 1A) is projected out of the aperture 51, 151 at a height much greater than the dimensions of the emitter.

In other words, if the detail of the image on the emitter is at a certain distance from the plane P and the underlying part of the emitter is black or dark, the technical effect achieved is that a detail of the image will be projected at a height much greater than the dimensions of the emitter.

As it is black or dark, the part of the image under the detail will not be considered by the observer and the detail will appear to be suspended at a considerable height with respect to the device.

The observer looks towards said second concave reflecting means 20, 120 along two visual cones CL, CR having respective directrices DIR_L, DIR_R.

In particular, with reference to FIGS. 2 and 5, the vertices VL, VR of the two cones CL, CR coincide with the observation points ΩL, ΩR of the observer.

In particular, the vertices VL, VR of the two cones CL, CR coincide with the observation points ΩL, ΩR of the observer, wherein the observation points ΩL, ΩR have a mean observation point ΩM and a predefined distance ΔΩ, as shown in FIGS. 2 and 5.

According to the invention, the cones CL, CR intersect the second concave reflecting means 20, 120 along respective distinct curves KL, KR having respective areas AL, AR.

In particular, the curves KL, KR are the curves obtained by intersecting the lateral surfaces of the cones CL, CR with the surfaces of the second concave reflecting means 20, 120.

In particular, the areas AL, AR are the areas delimited by the curves KL, KR on the second concave reflecting means 20, 120.

To offer a better understanding of one of the invention's principal technical effects, a brief description of the phenomenon of binocular vision in humans is provided herein below.

In 1915, for a description of the phenomenon of binocular vision, Worth proposed a subdivision of the developmental and cognitive process of the human visual system, as being made up of three different phenomena: (a) simultaneous perception or diplopia, (b) fusion, and (c) stereopsis. Each phenomenon is at a higher level than the preceding one, and the presence of the highest grade, stereopsis, comprises the presence of the previous two.
Simultaneous perception. Simultaneous perception is represented by the ability of both eyes to appreciate and transmit the same image to the brain in the same instant of time.
Fusion. Fusion is a visual ability that follows simultaneous perception and it has a motor component and a sensory component. The first involves the activity of the extraocular muscles, for the positioning of the visual axes on the object of interest. The second concerns the psychological ability to form a single visual representation from two similar retinal images.
Stereopsis. Stereopsis is the perceptual ability that makes it possible to join the images coming from both eyes, which because of their different structural positioning exhibit a lateral shift. This disparity is used by the brain to extract information on the depth and spatial position of the object of interest. As a result, stereopsis makes it possible to generate three-dimensional vision.

Our brain's detection system, which is virtually infallible for distances of less than one metre, is of no use in detections at greater distances. The basic cause of these limitations is to be found in the variation of the convergence of the eyes. In fact, when we observe an object that is moving away from the tip of our nose, said variation gradually passes from a maximum to negligible values. We can retain that the precision of the method essentially depends on the ratio between the distance of the points of observation with respect to each other and the distance of the object to be detected.

Considering that interpupillary distance, that is, the distance of the observation points with respect to each other, varies from one person to another and is around 6-7 cm and that the distance of distinct vision is 25 cm on average, experiments have verified that detection precision reaches a peak when this ratio is around 0.24-0.28, is the lowest at values of 0.06-0.07, and is unacceptable at lower values.

In particular, the device of the invention comprises detection of the distance of the object from the observer so as to ensure the effect of natural stereopsis for the observer, wherein the object is the displaying device.

The effect of natural stereopsis for the observer is ensured, but not only by the regulating of the emitting means and/or by the use of variable focal length mirrors.

For this purpose, according to the invention, a calculation unit 100 is associated with the device.

In one embodiment, the calculation unit 100 is associated with the device in proximity to it.

Alternatively, this unit is remotely located and in data communication with the device.

According to the invention, the calculation unit 100 is configured to calculate the positioning distance Ah along a reference direction dir_M defined as a function of the directrices DIR_L, DIR_R and of the third directions d3i.

In particular, the calculation unit 100 is configured to calculate the positioning distance Δh along the reference direction dir_M defined as a function of the point of intersection of the directrices P_INT and of the mean observation point ΩM.

According to the invention, the device further comprises regulating means 30, 40 adapted to vary the reference direction dir_M for determining a superposing measurement OVL of the areas AL, AR.

The technical effect achieved is a visual effect of the image IMM as a three-dimensional image, fluctuating and stereoscopic about a fluctuation point Φ for the observer located at the calculated positioning distance Δh.

By way of example, a mathematical treatment is presented now with non-limiting reference to the second embodiment of the invention which uses in particular two concave mirrors of a standard paraboloid shape as a particular case of the concave reflecting means 110, 120. For a clearer understanding, see FIG. 4B, which is a geometric representation of the device of the invention showing sections P1, P2 of the respective parabolic mirrors 110, 120.

First of all, let us consider the simple case of a longitudinal section of the device along a vertical plane of symmetry, containing the azimuth axis of symmetry of the two concave mirrors. Within the sphere of this description, let P1 and P2 be the sections of the two identical concave parabolic mirrors, of a focal length f>0, and which are coaxial, facing each other and arranged at a vertex-vertex distance equal to V̅₁̅V̅₂̅=c>0 so that the focus of one is close to the vertex of the other (FIGS. 4, 4b and 5). The locus of the points of the intersection space between the two mirrors is a circle of radius R (FIGS. 4, 4b and 5). The mirror with section P1 is cut at the height of the focus F22 of the mirror with section P2. This is shown particularly in FIG. 4, whereas in FIG. 5 the cut part is shown with dashed lines. In particular, the same cut can be made on the mirror with section P2 at the height of the focus F21 of the mirror with section P1. The hole is circular in shape and having a radius r.

A point source of light is responsible for producing light rays in all directions in the surrounding space. When a light ray is incident on a reflecting concave surface, it is generally reflected according to Snell's law of reflection. The direction of the reflected ray is part of the same plane of the incident ray and of the normal to the reflecting surface at the point of incidence. The angle formed by the reflected ray with the internal normal has the same value as the angle formed by the incident ray with the normal. In the case of a concave reflecting surface (mirror), the direction defined by the internal normals n at each reflection point P₀ varies as a function of the position of P₀ on the surface and it can be analytically calculated by means of the gradient of the parametric vector function defining the reflection surface Σ, calculated in P₀n(t)=P₀+∇Σ(P₀)t, where t is an arbitrary real parameter. In particular, using matrix formalism, the matrix describing the reflection of an incident light ray on a surface 1 is given by M₁≡I−2\hat{n}₁\hat{n}₁^{r}, where I is the unit matrix and \hat{n}₁ is the normal versor. We are therefore able to determine the direction of the straight line on which the reflected light ray lies, according to rᵣ(t)P₀+dᵣt, in which

$${d}_{r} = {d}_{i} - 2 \frac{{d}_{i} \cdot n}{{‖ n ‖}^{2}} n$$

defines the direction of the straight line, as a function of the direction dᵢ of the straight line on which the incident ray coming from the point source of light was initially lying. It can thus be noted from this treatment that initially parallel rays, which are incident on the reflecting surface at different points, can lose their initial parallelism following reflection.

In the specific case described, in the device this surface consists of a cross section of a paraboloid of rotation. Therefore, as it is a solid having azimuthal symmetry and a known analytic description, it is possible to obtain the tracing of the reflected light rays exactly and thus owing to the equations that follow, the algebraic and geometric development, it is possible to dimension the system properly.

As stated, the device further considers a second reflecting surface which is also concave and paraboloidal in shape. Therefore the ray reflected by the concave paraboloidal surface of the first mirror will prove to be an incident ray with respect to the concave paraboloidal surface of the second mirror. For the second reflection, a treatment similar to the one previously explained thus follows.

The geometric model constructed thus enables the rays coming from the light source (of images) and exiting from the device following double reflection (see FIG. 1) to be traced: taking two parallel light rays, they will be incident on the reflecting surface at two distinct points, having distinct normals that are no longer parallel with respect to each other, and thus the reflected rays will have directions that are no longer parallel to each other.

As shall be described in detail also herein below, when suitably dimensioned, the device is configured to cause enlargement/scaling-down phenomena and/or the overturning of the image.

When still turned upside-down by the first reflection, the image is turned right-side up owing to the second reflection, which projects the light rays in well-defined directions with respect to both eyes of the observer. With the exception of the improper beam of parallel lines of rays lying on the plane perpendicular to the reflecting surface with respect to the two observation points (corresponding to both eyes), each ray will have a deviated direction in space with respect to the initial direction. It shall thus reach the observer's eyes differently, generating the prerequisites for natural stereopsis thanks to the device of the invention.

Three-dimensional Case with Only One Observation Point (FIG. 4C)

What is seen by the observer through the circular aperture in the upper mirror with section P1 is a portion of the internal reflecting surface of the mirror with section P2, both being rotation paraboloids in shape, with a focal length f. Assuming the model of cone vision, with C(ξ, θ) (with ξ∈[0, h]eθ∈[0,2π[) we shall indicate the parametric form of the surface of a rotating cone (with a circular base and radius a, lying on the plane xy with an aperture angle φ=2actan (h/a) having the azimuth axis oriented along the axis z, and vertex at a height h from the base. For the purpose of orienting the cone according to any one orientation in space, the rotation matrices in space about the axes x and y, Rₓ(α)eR_{y}(β), are applied to C(ξ, θ), respectively, thus obtaining the vector describing the parametric form of the rotated conical surface C, \tilde{C}(ξ, θ; α, β), which must then be translated so that the vertex of the cone coincides with the observation point Ω(x_{Ω}, y_{Ω}, z_{Ω}). We shall indicate the rotated and translated cone with \tilde{C}(ξ, θ; α, β). We shall now examine the curve κ, obtained as the intersection of the rotated and translated vision cone Ĉ(ξ, θ; α, β; Ω) and the paraboloid (lower mirror) of section P2. Once the system has been resolved, an algebraic quadratic equation is obtained for the parameters the roots of which correspond to the two possible intersections of the cone with the paraboloid. At this point, the one that is useful for the description of the phenomenon is selected. We have indicated it as ξ̅ and we substitute it in the rotated and translated vision cone equation Ĉ(ξ, θ; α, β; Ω), thus obtaining the parametric equation (Equation 1) (dependent only on θ) of the curve κ being sought (FIG. 4C):

$$κ ( θ ) ≡ ( \begin{matrix}\{ [ cos ( 2 β ) cos θ + sin ( 2 α ) sin ( 2 β ) sin θ ] - \frac{h}{a} cos ( 2 α ) sin ( 2 β ) \} \\ [ sin ( 2 α ) + cos ( 2 α ) sin θ ] \\ \{ [ sin ( 2 β ) cos θ - sin ( 2 α ) cos ( 2 β ) sin θ ] + \frac{h}{a} cos ( 2 α ) cos ( 2 β ) \}\end{matrix} ) + ( \begin{matrix}{x}_{Ω} \\ {y}_{Ω} \\ {z}_{Ω}\end{matrix} ) .. \qquad [ Equation 1 ]$$

As is evident, when the position of the vertex of the cone and the orientation of the axis are changed, the curve changes. This explains the different view that is perceived when the observation point is changed.

Three-dimensional Case with Two or More Observation Points

The following mathematical treatment refers to the second embodiment shown in FIGS. 4, 4b and 5. A similar treatment can be deduced with reference to the first embodiment in FIGS. 1, 2 and 3.

Modelling of an observer's vision has been realised with the observer being in a position in which the interpupillary axis lies on a straight line parallel to the axis x and both eyes are equidistant from the plane yz (frontal vision). Let us then consider two cones Ĉ_{R} and Ĉ_{L} having the same h/a ratio (assuming here that the observer has emmetropic vision), and vertices VR and VL located at points Ω_{R}(x_{Ω}, y_{Ω}, z_{Ω}) and Ω_{L}(−x_{Ω}, y_{Ω}, z_{Ω}), (corresponding to the two observation points (right eye and left eye, respectively) where 2x_{Ω}=interpupillary distance≅6-7 cm. The inclination of their axis is symmetric with respect to the plane yz; thus the rotation angles in space α and β for the two cones satisfies α_{R}=α_{L}∧β_{R}=−β_{L}. The two cones intersect the paraboloid (lower mirror) of section P2 in two curves κ_{R}κ_{L}, respectively, which, like the portions of surface AR, AL, are symmetric with respect to the plane yz.

The superposing of the portions of surface AR, AL of the paraboloid (lower mirror) of section P2 changes depending on the observation point, that is, depending on the location of the vertices VR and VL, and the rotation angles α and β. The difference is responsible for stereoscopic vision, within the limits described previously on pages 21, 22 and 23 (stereopsis and related phenomena). Taking into account the intersection curve expression (Equation 1 reported above), it is thus possible to determine the dimensioning of the system so as to obtain the stereoscopic visual effect equal to natural human vision.

If the observer moves in such a manner that the straight line on which the interpupillary axis lies is no longer perpendicular to the plane yz, then the rays coming to the eyes will differ that much more, the smaller the angle formed between the interpupillary axis and the reference plane P. This will be tolerated within certain limits determined by human physiology and by psychological optics as described above.

Aside from these limits, the device of the invention comprises regulating means that ensures the above-mentioned measurement of superposing and the guarantee, for the observer, of a three-dimensional fluctuating and stereoscopic view of the image transmitted by the emitting means, even with a movement of the observer with respect to the object observed.

In other words, with reference to FIG. 1, advantageously, according to the invention, the regulating means 30, 40 is adapted to vary the reference direction Dir_M for setting, for each observer, a measurement M_OVL of the superposing OVL in a viewing range ΔM_OVL.

The viewing range ΔM_OVL, according to the invention, is comprised between:

a first lower limit measurement of superposing M_INF below which the observer is prevented from having a stereoscopic view;

a second upper measurement limit M_SUP above which the observer perceives the images as being substantially identical.

The technical effect achieved by means of the projection of the image IMM with the above-mentioned superposing measurement is the guarantee for the observer of a fluctuating and stereoscopic three-dimensional view of the image transmitted by the emitting means.

In further detail, the image IMM is exiting from the second concave reflecting means 20, 120 and from the aperture 51, 151, resulting in a 3D image. The image IMM is fluctuating as it is obtained outside of the device. The image is stereoscopic because it is perceived by both eyes.

According to the invention, the measurement M_OVL of the superposing OVL is in a first functional relation Rf_Δh with the positioning distance Δh.

According to the invention, the measurement M_OVL of the superposing OVL is in a second functional relation Rf_ΔΩ with the predefined distance ΔΩ.

The regulating means 30, 40 is adapted to regulate the functional relations Rf_Δh and Rf_ΔΩ so that the measurement of the superposing M_OVL shall be comprised within the range ΔM_OVL, which enables a 3D view that is fluctuating and stereoscopic.

In particular, if the measurement of the superposing M_OVL is close to the first lower limit measurement of superposing M_INF, this makes it possible to maximise the fluctuating and stereoscopic three-dimensional visual effect of the light rays R1i along the third directions d3i.

According to the invention, the lower limit measurement of superposing M_INF is a lower threshold value such that the first and second functional relations Rf_Δh, Rf_ΔΩ determine a ratio of the predefined distance ΔΩ to the projection distance δ<=˜0.28.

According to the invention, the second upper limit measurement M_SUP is an upper threshold value such that the first and second functional relations Rf_Δh, Rf_ΔΩ determine a ratio of the predefined distance ΔΩ to the viewing distance δ>=˜0.06.

It is deduced that the first lower limit measurement of superposing M_INF and the second upper limit measurement M_SUP define the viewing range ΔM_OVL within which the measurement M_OVL can vary.

To activate the regulating means 30, 40, the invention comprises a control apparatus DRIV (FIGS. 1 and 4) adapted to activate, as a function of the positioning distance Δh, one or more of said regulating means 30, 40.

The technical effect achieved is the regulation of the superposing measurement M_OVL in the range ΔM_OVL, as a function of the calculated positioning distance Δh, thus ensuring the effect of natural stereopsis for the observer.

According to the invention, with non-limiting reference to FIGS. 1, 2 and 5, the second reflecting means 20, 120, are configured to reflect the beam of light rays R1i along the third directions d3i about the fluctuation point Φ along the reference direction DIR_M.

The fluctuation point Φ and the mean observation point ΩM are arranged at a reciprocal viewing distance δ defined as a function of the fluctuation point Φ.

The fluctuation point Φ is calculated at a fluctuation distance ε_{L} from the second reflecting means 20, 120, particularly from a point Ψ, the intersection between the straight line DIR_M and the second reflecting means 20, 120 within the superposing surface OVL.

In particular, the positioning distance Δh is the distance calculated along the straight line DIR_M between the point ωM and the point Ψ, that is, Δh=ε_{L}+δ.

According to the invention, the fluctuation distance ε_{L} is in a third functional relation Rf_ε_{L} with the conformations Conf_12, Conf_22 and the first directions d1i.

In the real application, the following relations hold:

δ has a minimum value (˜25 cm) determined by human anatomy and physiology;

Δ

h has a minimum value determined by:
δ (how the eye works)
ξ (how the device is made)
OVL (how the brain works).

Experimentally it has been revealed that (assuming an interpupillary distance of 6-7 cm) stereoscopic vision is perceived in humans when the diversity of the two images coming to the brain through both eyes is such that the ratio between interpupillary distance and object-eye distance is within a range of values comprised between 0.6 and 0.28. Below 0.06 it is not stereoscopy (too far away=overlap perceived as “total”), whereas above 0.28 the brain no longer recomposes the images.

The calculation unit 100 is configured to calculate/determine one of more of the following:

the fluctuation point Φ;

the fluctuation distance ε_{L};

the viewing distance δ.

According to the invention, with non-limiting reference to FIG. 1, the device of the invention comprises support means 60 for the reflection system 50, 150 and adapted to support said reflection system 50,150.

The previously mentioned regulating means 30, 40 is adapted to regulate the position of the reflection system 50,150 on the support means 60.

The regulating means 30, 40 comprises electromechanical regulating means 30 adapted to regulate the position of the reflection system 50,150 on the support means 60.

The electromechanical regulating means 30 preferably comprises mechanical and/or pneumatic and/or electromagnetic means or the like.

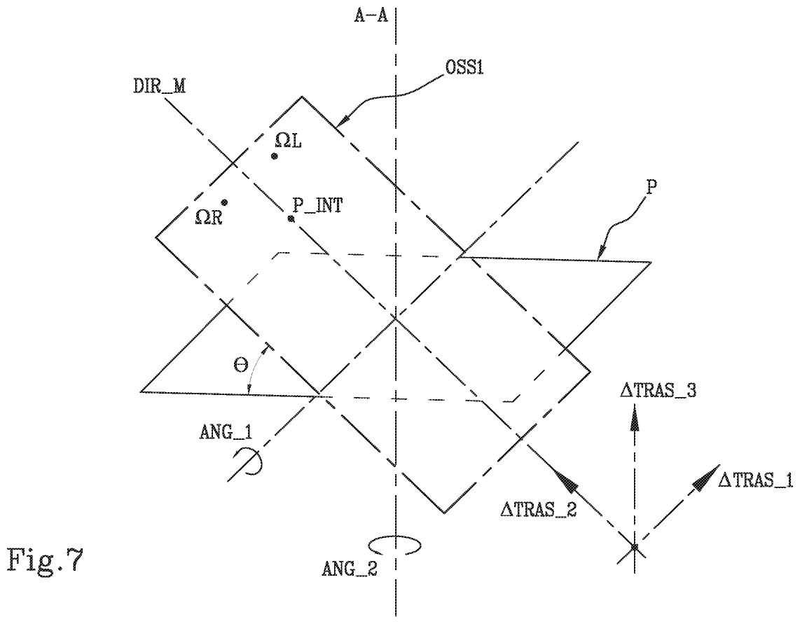

The following elements have been defined, with non-limiting reference to FIGS. 2 and 7, for comprehension of the regulating process carried out by the regulating means 30, 40:

a first plane OSS1 passing through the observation points ΩL, ΩR of the observer and the intersection point P_INT of the directrices;

a dihedral angle Θ (FIG. 7) formed by the first plane OSS1 and by the reference plane P associated with the reflection system 50, 150.

According to the invention, the regulating means 30 is adapted to determine a rotation ANG_1, ANG_2 (FIG. 7) and/or a translation Δ_TRAS1, Δ_TRAS2, Δ_TRAS3 (FIG. 7) of the reflection system 50, 150.

More specifically, referring particularly to FIG. 7, according to the invention, the electromechanical regulating means 30 is adapted to regulate one or more from among:
first rotation angle ANG_1 of the reference plane P, obtained by rotating the reference plane P about a fixed rotation axis corresponding to the intersecting line between the reference plane P and the first plane OSS1;
a second rotation angle ANG_2 of the reference plane P, obtained by rotating the reference plane P about a rotation axis corresponding to said azimuth axis A-A;
a measurement of a first translation Δ_TRAS 1 of the reflection system 50, 150 so that said reflection system 50, 150 translates along any one straight line belonging to the improper beam of parallel lines lying on the first plane OSS 1 and perpendicular to the reference direction DIR_M;
a measurement of a second translation Δ_TRAS2 of the reflection system 50, 150 so that the reflection system 50, 150 translates along any one straight line parallel to the reference direction DIR_M;
a measurement of a third translation Δ_TRAS3 of the reflection system 50, 150 so that the reflection system 50, 150 translates along any one straight line parallel to the azimuth axis A-A.

With non-limiting reference to FIGS. 1 and 4, the regulating means 40 comprises a control unit 40 configured to control the regulation of the reflection system 50, 150.

In general, it should be noted that in the present context and in the claims herein below, the control unit 40 is presented as being subdivided into distinct functional modules (memory modules or operating modules) for the sole purpose of describing the functions thereof clearly and thoroughly.

Actually, this control unit 40 can be constituted by a single electronic device, suitably programmed for performing the functions described, and the various modules can correspond to a hardware entity and/or routine software that are part of the programmed device.

Alternatively or additionally, these functions can be performed by a plurality of electronic devices in which the above-mentioned functional modules can be distributed.

The control unit 40 can also make use of one or more processors for execution of the instructions contained in the memory modules.

The above-mentioned functional modules can also be distributed in different computers, locally or remotely, based on the architecture of the network in which they reside.

According to the invention, the control unit 40 comprises:

a first direction regulation module 41 configured to regulate the first rotation angle ANG_1;

a second direction regulation module 42 configured to regulate the second rotation angle ANG_2;

a first translation regulation module 43 configured to regulate a measurement of the first translation Δ_TRAS1;

a second translation regulation module 44 configured to regulate a measurement of the second translation Δ_TRAS2;

a third translation regulation module 45 configured to regulate a measurement of the third translation Δ_TRAS3.

The control apparatus DRIV mentioned hereinabove is adapted to activate, as a function of the positioning distance Δh, one or more from among the regulating means 30, 40 for regulating one or more from among:
the first rotation angle ANG_1;
the second rotation angle ANG_2;
the measurement of the first translation Δ_TRAS1;
the measurement of the second translation Δ_TRAS2;
the measurement of the third translation Δ_TRAS3.

In one embodiment of the invention, which is not illustrated in the figures, the control apparatus DRIV comprises the calculation unit 100 configured to calculate the positioning distance Ah along the reference direction dir_M defined as a function of the directrices DIR_L, DIR_R) and the third directions d3i.

Preferably, the control apparatus DRIV is a suitable remote control supplied to the observer, with which the observer brings about the regulation of the regulating means 30, 40 from the observation position in which he/she is in, thus bringing about a regulation of the device of the invention which enables him/her to benefit by the effect of natural stereopsis.

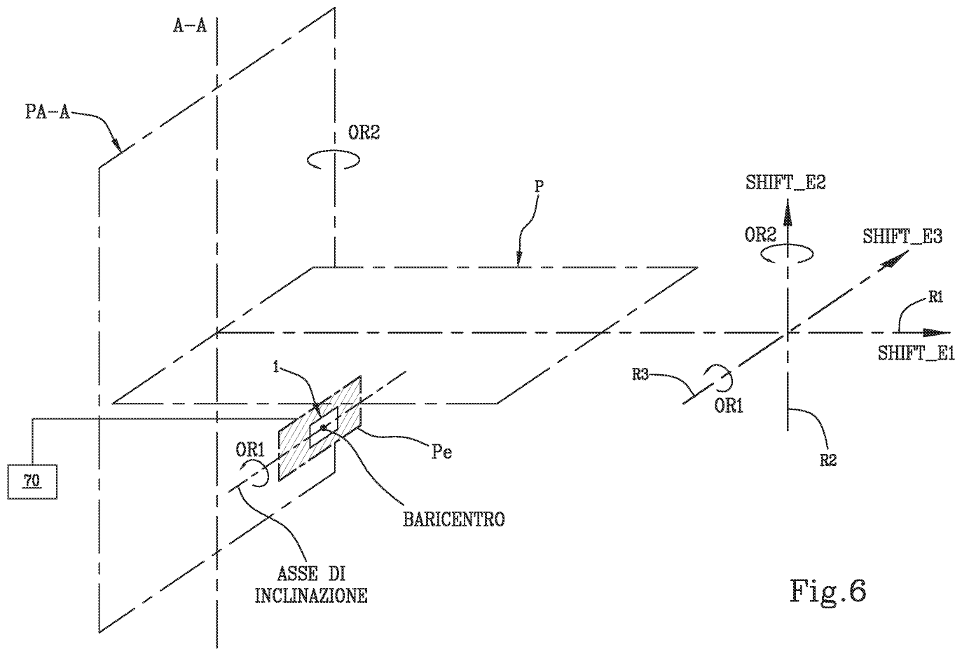

The emitting means 1 shall now be described in further detail, referring particularly to FIG. 6.

For a better understanding of the movements of the emitting means 1, an azimuth plane PA-A is defined as a plane containing the azimuth axis A-A, perpendicular to the reference plane P and parallel to the straight line conjoining the extremities of the arc of circumference C_int or generic portion of flat curve obtained by intersecting the first 10,110 and second 20,120 reflecting means.

According to the invention, with particular reference to FIG. 6, the emitting means 1 lies on an emitting plane Pe having:
a first angulation OR1 with respect to the reference plane P; in other words, the first angulation OR1 is obtained by rotating the emitting plane Pe about a straight line parallel to the reference plane P, parallel to the azimuth plane PA-A and passing through the centre of gravity of the emitting means 1;
a second angulation OR2 obtained by rotating the emitting plane Pe about a rotation axis corresponding to the straight line perpendicular to the reference plane P, parallel to the azimuth axis A-A and passing through the centre of gravity of the emitting means 1.

According to the invention, the first angulation OR1 is in a functional relation Rf_Θ1 with the dihedral angle Θ formed by the first plane OSS1 with the reference plane P. A regulation of the first angulation OR1 minimises the angle of exit of the beam of light rays R1i from the apertures 51, 151 along said third directions d3i with respect to a straight line parallel to the azimuth axis A-A, thus enabling projection of vertical images.

According to the invention, a regulation of the angulation OR2 brings about a maximisation of the angle of vision of the observer.

In other words, if the emitting means 1 is oriented in a manner not in accordance with the first directions d1i, the reflection system 50, 150 will determine an angle of vision for the observer that is not suited to benefitting from the stereopsis effect, thus preventing correct vision on the observer's part.

The macroscopic technical effects achieved with the regulations OR1, OR2 are the exiting effect, particularly verticalisation, of the image or sequence of images and natural stereoscopic vision on the observer's part.

Referring particularly to FIG. 6, the emitting means 1 is translatable as a function of:

a first translation value SHIFT_E1 along a first straight line R1 contained in the reference plane P, perpendicular to the azimuth plane PA-A and passing through the azimuth axis A-A.

The technical effect achieved is an enlargement of the fluctuating image if the emitting means translates from the azimuth axis A-A towards the curve C_Int and a reduction if the means translates in the opposite direction.

a second translation value SHIFT_E2 along a second straight line r2 parallel to the azimuth axis A-A.

The technical effect achieved is a maximisation of the vertical position of the image so that the image is completely visible depending on the enlargement value selected by means of SHIFT_E1.

a third translation value SHIFT_E3 along a third straight line R3 contained in the reference plane P and parallel to the azimuth plane PA-A.

The technical effect achieved is a maximisation of the horizontal position of the image so that the image is completely visible depending on the enlargement value selected by means of SHIFT_E1.

According to the invention, the first translation value SHIFT_E1, the second translation value SHIFT_E2 and the third translation value SHIFT_E3 define a trio of translation values TRAS_E for the emitting means 1.

In other words:
SHIFT_E1 represents a forward-backward translation of the emitting means along the straight line R1.
With reference to FIG. 6, the first translation value SHIFT_E1 occurs along a Cartesian axis X (coinciding with the direction of the first straight line R1) of a trio of Cartesian axes X,Y,Z, determining a movement defined as a forward-backward shifting movement of the emitting means.
SHIFT_E2 represents an up-down translation of the emitting means with respect to the reference plane P.
With reference to FIG. 6, the second translation value SHIFT_E2 occurs along a Cartesian axis Y (coinciding with the direction of the second straight line R2) of the trio of Cartesian axes X,Y,Z, determining a movement defined as an up-down shifting movement of the emitting means.
SHIFT_E3 represents a left-right translation of the emitting means with respect to a plane perpendicular to the reference plane P, perpendicular to the azimuth plane PA-A and passing through the centre of gravity of the emitting means.
In other words, SHIFT_E3 represents a left-right translation of the emitting means with respect to a plane passing through a straight line lying on the reference direction dir_M and perpendicular to the reference plane P (FIGS. 1 and 2).
With reference to FIG. 6, the third translation value SHIFT_E3 occurs along a Cartesian axis Z (coinciding with the direction of the third straight line R3) of the trio of Cartesian axes X,Y,Z, determining a movement defined as a left-right shifting movement of the emitting means.

The technical effect achieved as a function of the trio of translation values is the regulation of the dimension of the image IMM or sequence of images defined by the beam of light rays R1i along the third directions d3i and exiting from the apertures 51, 151.

Regulation is further defined within a translation range ΔTRAS_E.

According to the invention, the emitting means 1 is translatable between:
a first limit value TRAS_EMIN in the trio of values TRAS-E when
   the beam of light rays R1i along the second directions d2i away from the first concave reflecting means 10, 110 intersects the second concave reflecting means 20, 120 inside at least one of the areas AR, AL;
   the emitting means 1 does not intersect at least one of the cones CR, CL;
a second limit value TRAS_EMAX in the trio of values TRAS-E when:
   the beam of light rays R1i along the third directions d3i away from the second concave reflecting means 20, 120 intersects the area inside the border defined by the aperture 51, 151;
   the emitting means 1 does not intersect at least one of the cones CR, CL;
wherein the limit values TRAS_EMIN and TRAS_EMAX define a range ΔTRAS_E;
wherein said trio of values TRAS_E takes on values within the range ΔTRAS_E.

The technical effect achieved is an enlargement or reduction of the images with respect to the images emitted by the emitting means 1 so as to display fluctuating images in different sizes as a function of the required image size target.

According to the invention, the device further comprises translation means 70 (non-limitingly shown only in FIGS. 1 and 6) of the emitting means 1 adapted to translate the emitting means 1 in one or more directions of the straight lines R1, R2, R3.

The translation means 70 preferably comprises motors, particularly stepper motors. According to the invention, the light field volumetric device of the invention further comprises a basic embodiment in which the device determines a superposing measurement OVL of the areas AL, AR, thereby realizing a visual effect of the image IMM as a three-dimensional image, fluctuating and stereoscopic about a fluctuation point Φ for an observer located at a predefined positioning distance Δh, from the second reflecting means 20, 120, along a reference direction dir_M defined as a function of the directrices DIR_L, DIR_R and the third directions d3i.

One specific application of the invention is a television for projecting flows of fluctuating and stereoscopic 3D images comprising:

receiving means for receiving a digital televisual signal TV_Sn;

a light field volumetric device for displaying flows of fluctuating and stereoscopic 3D image, as described hereinabove, and configured to receive a digital televisual signal TV_Sn.

The emitting means 1 is configured to:

receive an input signal INPUT defined as a function of the digital televisual signal TV_Sn;

emit a beam of light rays R1i representing a two-dimensional image flow, the images being defined as a function of said input signal INPUT;

the device of the invention is configured to realise a visual effect of a three-dimensional image IMM, fluctuating and stereoscopic about a fluctuation point Φ for an observer located at a calculated positioning distance Δh, as disclosed in the entire description, starting from the beam of light rays R1i.

The invention also discloses a method of displaying images or flows of fluctuating and stereoscopic 3D images comprising the steps of:

predisposing emitting means 1,

predisposing a reflection system 50, 150, coupled to the emitting means 1, comprising first concave reflecting means 10, 110 and second concave reflecting means 20, 120;

predisposing the first concave reflecting means 10, 110 mounted, with respect to the second concave reflecting means 20, 120, with concavities C_10, C_110; C_20, C_120 facing one another and coaxial;

predisposing foci F11, F12; F21, F22 of the first concave reflecting means 10, 110 and of the second concave reflecting means 20,120 lying on a straight line that defines the azimuth axis A-A of the reflection system 50,150;

intersecting the first concave reflecting means 10, 110 and the second concave reflecting means 20, 120, or prolongations thereof, along an intersection curve C_int lying on a reference plane P perpendicular to the azimuth axis A-A of the reflection system 50, 150;

transmitting by the emitting means 1, a beam of light rays R1i representing a two-dimensional image flow, in first directions d1i;

receiving the beam of light rays R1i by the first concave reflecting means 10, 110 and reflecting the beam in second directions d2i obtained as a function of the first directions d1i and of a first conformation Conf11, Conf21 of the first concave reflecting means 10, 110;

receiving said beam of light rays R1i along the second directions d2i by the second concave reflecting means 20,120 and reflecting the beam in third directions d3i obtained as a function of the second directions d2i and of a second conformation Conf12; Conf22 of the second concave reflecting means 20;120;

predisposing an aperture 51, 151 in the first concave reflecting means 10, 110 configured so that the beam of light rays R1i, reflected by the second concave reflecting means 20,120, exits from the reflection system 50,150 along the third directions d3i through the at least one aperture 51, 151.

wherein an image IMM generated as a function of the beam of light rays R1i is perceived by an observer, located at a positioning distance Δh with respect to the second concave reflecting means 20, 120, when the observer looks towards the second concave reflecting means 20, 120 along two visual cones CL, CR having respective directrices DIR_L, DIR_R,

causing vertices VL, VR of the two cones CL, CR to coincide with the observation points ΩL, ΩR of the observer,

intersecting the cones CL, CR and the second concave reflecting means 20, 120 along respective distinct curves KL, KR having respective areas AL, AR;

calculating the positioning distance Ah along a reference direction dir_M defined as a function of the directrices DIR_L, DIR_R and of the third directions d3i;

varying said reference direction dir_M for determining a superposing measurement OVL of said areas AL,AR, thus realising a visual effect of said image IMM as a three-dimensional image, fluctuating and stereoscopic about a fluctuation point Φ for the observer located at the calculated positioning distance Δh.

The step of causing the vertices VL, VR of the two cones CL, CR to coincide with the observation points ΩL, ΩR of the observer is preferably realised so that the observation points ΩL, ΩR have a mean observation point ΩM and a predefined distance ΔΩ.

The positioning distance Δh along a reference direction dir_M is preferably calculated as a function of the point of intersection of the directrices P_INT and of the mean observation point ΩM.

The method preferably comprises steps that realise the functions of the technical components not described in relation to the device(s) and/or system(s) of the invention.

According to the invention, the method is characterized in that it is implemented by means of a computer.

The invention further discloses a computer program configured to carry out one or more steps of the method, when running.

In conclusion, the invention disclosed achieves the following principal technical effects, the optimisation of which is in mutual opposition operationally: on the one hand, the effect of natural human stereopsis (i.e., the perception of images provided with depth) and on the other hand, the effect of enlargement and exiting of the 3D image starting from a 2D image.

1.-17. (canceled)

18. A light field volumetric device for displaying images or flows of fluctuating and stereoscopic 3D images, comprising:
i) emitting means configured for transmitting a beam of light rays in first directions representing a two-dimensional image flow;
ii) a reflection system, coupled to said emitting means, in turn comprising:
iia) first concave reflecting means configured to receive said beam of light rays and to reflect said beam in second directions obtained as a function of said first directions and of a first conformation of the first concave reflecting means, and
iib) second concave reflecting means configured to receive said beam of light rays along said second directions and to reflect said beam in third directions obtained as a function of said second directions and of a second conformation of the second concave reflecting means,
wherein said first concave reflecting means is mounted, with respect to said second concave reflecting means, with concavities facing one another and coaxial,
wherein foci of said first concave reflecting means and of said second concave reflecting means lie on a straight line that defines the azimuth axis of the reflection system,
wherein said first concave reflecting means and said second concave reflecting means, or prolongations thereof, intersect along an intersection curve lying on a reference plane perpendicular to said azimuth axis of the reflection system,
wherein said first concave reflecting means comprises at least one aperture configured so that said beam of light rays, reflected by the second concave reflecting means, exits from said reflection system along said third directions through said at least one aperture,
wherein an image generated as a function of the beam of light rays is perceivable by an observer, located at a positioning distance with respect to said second concave reflecting means, when the observer looks towards said second concave reflecting means along two visual cones having respective directrices,
wherein vertices of the two cones coincide with the observation points of the observer, and
wherein said cones intersect said second concave reflecting means along respective distinct curves having respective areas;
iii) a calculation unit configured to calculate said positioning distance along a reference direction defined as a function of said directrices and of said third directions; and
iv) regulating means configured to vary said reference direction for determining a superposing measurement of said areas, thus forming a visual effect of said image as a three-dimensional image, fluctuating and stereoscopic about a fluctuation point for said observer located at said calculated positioning distance.

19. The device according to claim 18, wherein said emitting means is offset with respect to said azimuth axis.

20. The device according to claim 19, wherein:
said emitting means is configured to emit the beam of light rays via a first portion of emitting means arranged at a first mean distance from the reference plane,
said emitting means further comprises a second portion of emitting means arranged at a second mean distance from the reference plane, wherein the second mean distance is smaller than the first mean distance, and
the second portion of emitting means is black or dark.

21. The device according to claim 18, wherein vertices of the two cones coincide with the observation points of the observer, said observation points having a mean observation point and a predefined distance.

22. The device according to claim 21, wherein said calculation unit is configured to calculate said positioning distance along said reference direction defined as a function of the point of intersection of the directrices and of said mean observation point.

23. The device according to claim 18, wherein:
said first concave reflecting means is mounted superiorly with respect to said second concave reflecting means with respective concavities facing one another and coaxial, wherein said reference plane separates the first concave reflecting means from the second concave reflecting means; or
said aperture is carried out at a focus of said second concave reflecting means.

24. The device according to claim 18, wherein said regulating means is configured to vary said reference direction for setting, for each said observer, a measurement of said superposing in a viewing range comprised between:
a first lower limit measurement of superposing below which said observer is prevented from having a stereoscopic view; and
a second upper measurement limit above which said observer perceives said images as substantially identical.

25. The device according to claim 24, wherein said measurement of said superposing is in a first functional relation with said positioning distance and in a second functional relation with said predefined distance.

26. The device according to claim 18, wherein
said fluctuation point is positioned along said reference direction,
said fluctuation point and said mean observation point are arranged at a reciprocal viewing distance defined as a function of said fluctuation point, and
said fluctuation point is calculated at a fluctuation distance from said second reflecting means.

27. The device according to claim 26, wherein said fluctuation distance is in a functional relation with said conformations and said first directions.

28. The device according to claim 18, wherein said regulating means comprises one from between:
electromechanical regulating means configured to regulate the position of said reflection system, on support means of said reflection system, configured to support said reflection system;
a co unit configured to control said regulation of said reflection system.

29. The device according to claim 28, wherein said support means comprises at least one of mechanic, pneumatic or electromagnetic means.

30. The device according to claim 28, wherein said electromechanical regulating means is configured to regulate one or more from among:
a first rotation angle of the reference plane, obtained by rotating the reference plane about a fixed rotation axis corresponding to the intersecting line between said reference plane and a first plane passing through said observation points and through said intersection point;
a second rotation angle of said reference plane, obtained by rotating the reference plane about a fixed rotation axis corresponding to said azimuth axis;
a measurement of a first translation of said reflection system so that said reflection system translates along any straight line belonging to the improper beam of parallel lines lying on said first plane and perpendicular to said reference direction;
a measurement of a second translation of said reflection system so that said reflection system translates along any one straight line parallel to said reference direction; and
a m2asurement of a third translation of said reflection system so that said reflection system translates along any one straight line parallel to said azimuth axis.

31. The device according to claim 28, comprising a control apparatus configured to activate, as a function of said positioning distance, one or more from among said regulating means for regulating one or more from among:
said first rotation angle;
said second rotation angle;
said measurement of said first translation;
said measurement of said second translation; and
said measurement of said third translation,
said control apparatus comprising said calculation unit configured to calculate said positioning distance along said reference direction defined as a function of said directrices and said third directions.

32. The device according to claim 18, wherein:
i) said emitting means lies on an emitting plane having:
ia) a first angulation obtained by rotating the emitting plane about a straight line parallel to the reference plane, parallel to an azimuth plane and passing through the centre of gravity of the emitting means, wherein said first orientation is in a functional relation with a dihedral angle formed by said first plane and said reference plane,
where in said azimuth plane is a plane containing said azimuth axis, perpendicular to said reference plane and parallel to the straight line conjoining the extremities of said arc of circumference or portion of flat curve obtained by intersecting said first and second reflecting means, and
where in the regulation of said first angulation minimises the angle of exit of the beam of light rays from the apertures along said third directions with respect to a straight line parallel to the azimuth axis, thus enabling projection of vertical images, and
ib) a second angulation obtained by rotating the emitting plane about a rotation axis corresponding to the straight line perpendicular to the reference plane, parallel to an azimuth axis and passing through the centre of gravity of the emitting means,
where in said second angulation is configured to maximize the angle of vision of the observer; or
ii) said emitting means is translatable as a function of:
iia) a first translation value of said emitting means along a straight line contained in the reference plane, perpendicular to the azimuth plane and passing through the azimuth axis,
iib) a second translation value of the emitting means along a straight line parallel to the azimuth axis, and
iic) a third translation value of said emitting means along a straight line contained in the reference plane and parallel to the azimuth plane,
wherein said first translation, second translation value and third translation value define a trio of translation values for said emitting means.

33. A light field volumetric device for displaying images or flows of fluctuating and stereoscopic 3D images, comprising:
i) emitting means configured for transmitting a beam of light rays in first directions representing a two-dimensional image flow; and
ii) a reflection system, coupled to said emitting means, in turn comprising:
iia) first concave reflecting means configured to receive said beam of light rays and to reflect said beam in second directions obtained as a function of said first directions and of a first conformation of the first concave reflecting means, and
iib) second concave reflecting means configured to receive said beam of light rays along said second directions and to reflect said beam in third directions obtained as a function of said second directions and of a second conformation of the second concave reflecting means,
wherein said first concave reflecting means is mounted, with respect to said second concave reflecting means with concavities facing one another and coaxial,
wherein foci of said first concave reflecting means and of said second concave reflecting means lie on a straight line that defines the azimuth axis of the reflection system,
wherein said first concave reflecting means and said second concave reflecting means, or prolongations thereof, intersect along an intersection curve lying on a reference plane perpendicular to said azimuth axis of the reflection system,
wherein said first concave reflecting means comprises at least one aperture configured so that said beam of light rays, reflected by the second concave reflecting means, exits from said reflection system along said third directions through said at least one aperture,
wherein an image generated as a function of the beam of light rays is perceivable by an observer, located at a predefined positioning distance with respect to said second concave reflecting means, when the observer looks towards said second concave reflecting means along two visual cones having respective directrices,
wherein vertices of the two cones coincide with the observation points of the observer,
wherein said cones intersect said second concave reflecting means along respective distinct curves having respective areas, and
wherein the device is configured to determine a superposing measurement of said areas, thus forming a visual effect of said image as a three-dimensional image, fluctuating and stereoscopic about a fluctuation point for an observer located at a predefined positioning distance along a reference direction defined as a function of said directrices and said third directions.

34. A television for projecting images or flows of fluctuating and stereoscopic 3D images comprising:
receiving means of a digital televisual signal; and
the light field volumetric device according to claim 18, configured for receiving said digital televisual signal,
wherein
said emitting means is configured to receive an input signal defined as a function of the digital televisual signal and emit a beam of light rays representing a two-dimensional image flow defined as a function of said input signal, and
the light field volumetric device is configured to form a visual effect of a three-dimensional image, fluctuating and stereoscopic about said fluctuation point for said observer located at a calculated positioning distance.

35. A television for projecting images or flows of fluctuating and stereoscopic 3D images comprising:
receiving means of a digital televisual signal; and
the light field volumetric device according to claim 33, configured for receiving said digital televisual signal,
wherein
said emitting means is configured to receive an input signal defined as a function of the digital televisual signal and emit a beam of light rays representing a two-dimensional image flow defined as a function of said input signal, and
the light field volumetric device is configured to form a visual effect of a three-dimensional image, fluctuating and stereoscopic about said fluctuation point for said observer located at a calculated positioning distance.

36. A method of displaying images or flows of fluctuating and stereoscopic 3D images comprising the steps of:
predisposing emitting means;
predisposing a reflection system, coupled to said emitting means, comprising first concave reflecting means and second concave reflecting means;
predisposing said first concave reflecting means mounted, with respect to said second concave reflecting means with concavities facing one another and coaxial;
predisposing foci of said first concave reflecting means and of said second concave reflecting means lying on a straight line that defines the azimuth axis of the reflection system;
intersecting said first concave reflecting means and said second concave reflecting means, or prolongations thereof, along an intersection curve lying on a reference plane perpendicular to the azimuth axis of the reflection system;
transmitting by said emitting means, a beam of light rays representing a two-dimensional image flow, in first directions;
receiving said beam of light rays by the first concave reflecting means and reflecting said beam in second directions obtained as a function of said first directions and of a first conformation of the first concave reflecting means;
receiving said beam of light rays along said second directions by second concave reflecting means and reflecting said beam in third directions obtained as a function of said second directions and of a second conformation of the second concave reflecting means;
predisposing an aperture in said first concave reflecting means configured so that said beam of light rays, reflected by the second concave reflecting means, exits from said reflection system along said third directions through said at least one aperture,
wherein an image generated as a function of the beam of light rays is perceivable by an observer, located at a positioning distance with respect to said second concave reflecting means, when the observer looks towards said second concave reflecting means along two visual cones having respective directrices;
causing vertices of the two cones to coincide with the observation points of the observer;
intersecting said cones and said second concave reflecting means along respective distinct curves having respective areas;
calculating said positioning distance along a reference direction defined as a function of said directrices and said third directions; and
varying said reference direction for determining a superposing measurement of said areas, thus forming a visual effect of said image as a three-dimensional image, fluctuating and stereoscopic about a fluctuation point for said observer located at said calculated positioning distance.
